(19) United States
(12) Patent Application Publication
(10) Pub. No.: US 2010/0175896 A1
(43) Pub. Date: Jul. 15, 2010

(54) CATALYTIC OIL RECOVERY

(75) Inventor: Ryan O. Owen, Houston, TX (US)

Correspondence Address: CAROL WILSON;BP AMERICA INC., MAIL CODE 5 EAST, 4101 WINFIELD ROAD, WARRENVILLE, IL, 60555, US

(73) Assignee: BP CORPORATION NORTH AMERICA INC., Warrenville, IL (US)

(21) Appl. No.: 12/685,588

(22) Filed: Jan. 11, 2010

Related U.S. Application Data
(60) Provisional application No. 61/143,493, filed on Jan. 9, 2009.

(51) Int. Cl. E21B 43/16; C09K 8/588

(52) U.S. Cl. 166/401; 507/229

(57) ABSTRACT

Methods and compositions for catalytic heavy oil recovery are disclosed herein. The disclosed methods utilize novel colloidal catalysts, which may catalyze hydrogenation reactions in heavy oil deposits. These colloidal catalysts are dispersible in liquid dispersants, which are also injected into the reservoir. Embodiments of the disclosed method enable the distribution of catalytic particles throughout portions or all of the reservoir. The H₂ injected is also transported throughout the reservoir by diffusion and or bulk flow. On coming in contact with the catalyst, hydrogen and components of the crude oil react to produce a lighter, more hydrogenated crude. This results in a reduction in viscosity of the crude oil, which in turn may enable higher reservoir recoveries.

### CROSS-REFERENCE TO RELATED APPLICATIONS

This application claims the benefit of U.S. provisional application Ser. No. 61/143,493 filed Jan. 9, 2009, and entitled “Catalytic Oil Recovery,” which is hereby incorporated herein by reference in its entirety for all purposes.

### STATEMENT REGARDING FEDERALLY SPONSORED RESEARCH OR DEVELOPMENT

Not applicable.

### BACKGROUND

1. Field of the Invention

This invention relates generally to the field of oil and gas recovery. More specifically, the invention relates to methods of catalytic heavy oil recovery.

2. Background of the Invention

Heavy oil, extra-heavy oil, and bitumen are unconventional oil resources that are characterized by high viscosities (i.e. resistance to flow) and high densities compared to conventional oil. The International Energy Agency (IEA) estimates that there are 6 trillion (6×10¹²) barrels in place worldwide; with 2.5×10¹² bbl in Western Canada, 1.5×10¹² bbl in Venezuela, 1×10¹² bbl in Russia, and 100 to 180×10⁹ bbl in the United States. Accordingly, heavy oil, extra-heavy oil, and bitumen deposits represent a vast natural resource which remains largely inaccessible due to their physical properties.

Although most heavy oil, extra-heavy oil, and bitumen deposits are very shallow, the viscous nature of these deposits makes recovery difficult and problematic. These deposits originated as conventional oil that formed in deep formations, but migrated to the surface region where they were degraded by bacteria and by weathering, and where the lightest hydrocarbons escaped. In addition, heavy oil, extra-heavy oil, and bitumen are deficient in hydrogen and have high carbon, sulfur, and heavy metal content. Hence, they require additional processing (upgrading) to become a suitable feedstock for a normal refinery.

Due to heavy oil's properties, the recovery and processing of heavy oil previously has been unprofitable due to technological limitations and high capital investment. However, the development of new technologies and the increase in the price of oil has opened up new possibilities with respect to heavy oil recovery. Some examples of current recovery techniques include open-pit mining, cold-production horizontal wells, water flooding, cold production with sand, steam flooding, solvent with or without heat and/or steam, etc. Open-pit mining is a mature technology and only evolutionary improvements in technology are likely. However, open-pit mining has a large environmental impact which is seen as a large liability by some. By contrast, there are several commercial in situ production technologies, and several more in research or pilot phase. Many of the in situ production methods require an external energy source to heat the heavy oil to reduce its viscosity. Natural gas is currently the predominant fuel used to generate steam, but it is becoming more expensive due to short supply in North America. Alternative fuels such as coal, heavy oil, or byproducts of heavy oil upgrading could be used, but simply burning them will release large quantities of CO₂, a greenhouse gas.

Consequently, there is a need for alternative and more effective methods of heavy oil recovery.

### BRIEF SUMMARY

Methods and compositions for catalytic heavy oil recovery are disclosed herein. The disclosed methods utilize novel colloidal catalysts, which may catalyze hydrogenation reactions in heavy oil deposits. These colloidal catalysts may be dispersible in supercritical fluids, which are also injected into the reservoir.

Embodiments of the disclosed method enable the distribution of catalytic particles throughout parts or all of the reservoir. The H₂ injected with the colloidal dispersion is also transported throughout the reservoir by diffusion and or bulk flow. On coming in contact with the catalyst, hydrogen and components of the crude oil react to produce a lighter, more hydrogenated crude. This results in a reduction in viscosity of the crude oil, which in turn enables high reservoir recoveries.

In an embodiment, a method of oil recovery comprises mixing a colloidal catalyst with a liquid dispersant to form a colloidal dispersion. The colloidal catalyst comprises nanoparticles. In addition, the method comprises injecting hydrogen and the colloidal dispersion into a subterranean formation containing oil. The subterranean formation has a formation temperature. The method further comprises allowing the hydrogen and the colloidal dispersion to diffuse into the subterranean formation and react with the oil. The colloidal dispersion catalyzes hydrogenation of the oil at a temperature no greater than the formation temperature to reduce the viscosity of the oil.

In another embodiment, a method of reducing heavy oil viscosity to enhance heavy oil recovery comprises injecting catalytic nanoparticles dispersed in a liquid dispersant into a subterranean formation containing heavy oil.

Because the catalyst under consideration is capable of catalyzing reactions at temperatures as low as 50° C., no heat or significantly less amounts of heat need to be added to the reservoir to enable the reactions to proceed at useful rates. Thus the process can be applied to the majority of reservoirs as most oil fields are at temperatures above 50° C. Further aspects and details of the methods are described in more detail below.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of a method of catalytic heavy oil recovery.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

As used herein, the term “colloidal catalyst” may refer to catalysts which remain dispersed or suspended evenly in solution without dissolving in solution.

As used herein, the term “nanoparticle(s)” may refer to particles having an average diameter ranging from about 1 nm to about 1000 nm.

As used herein, the term “heavy oil” may refer to oils having a viscosity greater than about 100 centapoise (cp) at reservoir temperature. The term “heavy oil” also encompasses extra heavy oil and bitumen, as described below.

As used herein, the term “bitumen” may refer to oil having a viscosity greater than about 10,000 cp.

As used herein, the term “extra heavy oil” may refer to oil have an API gravity of less than about 10° and a viscosity less than 10,000 cp, but greater than 100 cp.

As used herein, the term “oil” may refer to any liquid hydrocarbons or mixture of hydrocarbons found beneath the earth's surface.

As used herein, the term “supercritical fluid” may refer to any substance at a temperature and pressure above its thermodynamic critical point. Supercritical fluids exhibit unique solubility and compressibility characteristics. The term “critical point” may refer to the conditions (temperature and pressure) at which a phase boundary ceases to exist for any given substance.

### DETAILED DESCRIPTION OF THE PREFERRED EMBODIMENTS

Generally, embodiments of the disclosed process call for the in situ upgrading or lightening of oil in situ in a reservoir using a colloidal catalyst. The most likely applicability of embodiments of the disclosed method is with viscous oils, but the methods may be applied to the recovery of all oils from light to heavy. In general, the method comprises injecting one or more colloidal catalysts into a heavy oil reservoir for the in situ (oil field) upgrading of heavy oil. Specifically, the method comprises injecting colloidal catalysts as described above into a reservoir in a liquid dispersant or carrier fluid. The colloidal catalysts are dispersed in the dispersant to form a colloidal dispersion also known as a sol. Hydrogen (H₂) gas may also be dissolved in the dispersion. The colloidal dispersion dissolves in the oil in the reservoir upon injection (or some distance into the reservoir from the injection point), and colloidal catalyst particles are transported throughout the reservoir by diffusion or by other transport mechanisms. Because of the small diameters of the particles, the catalyst may be capable of traveling through the pores of the reservoir.

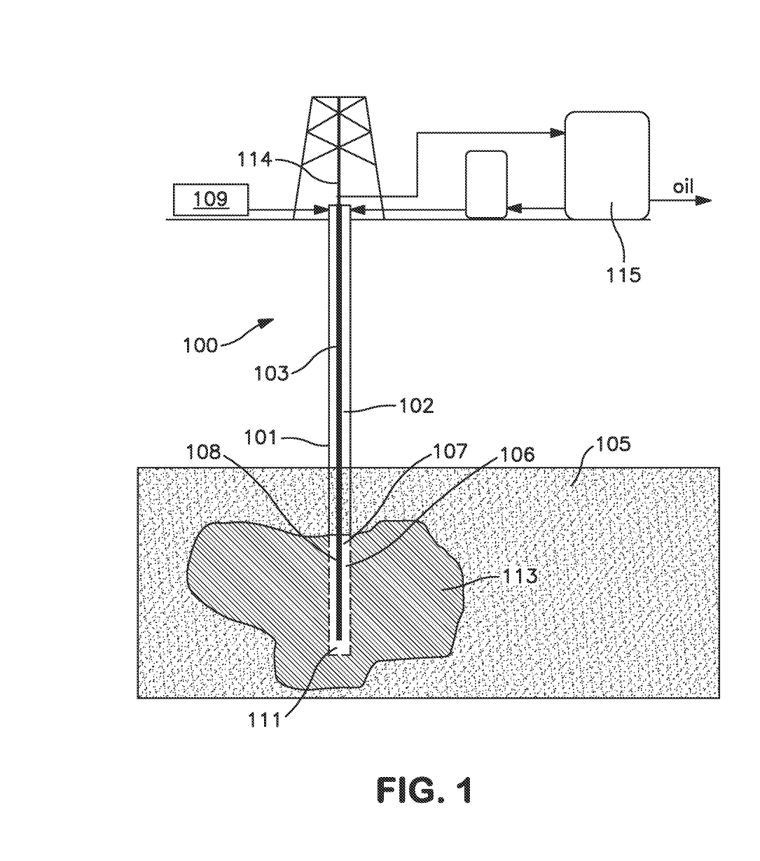

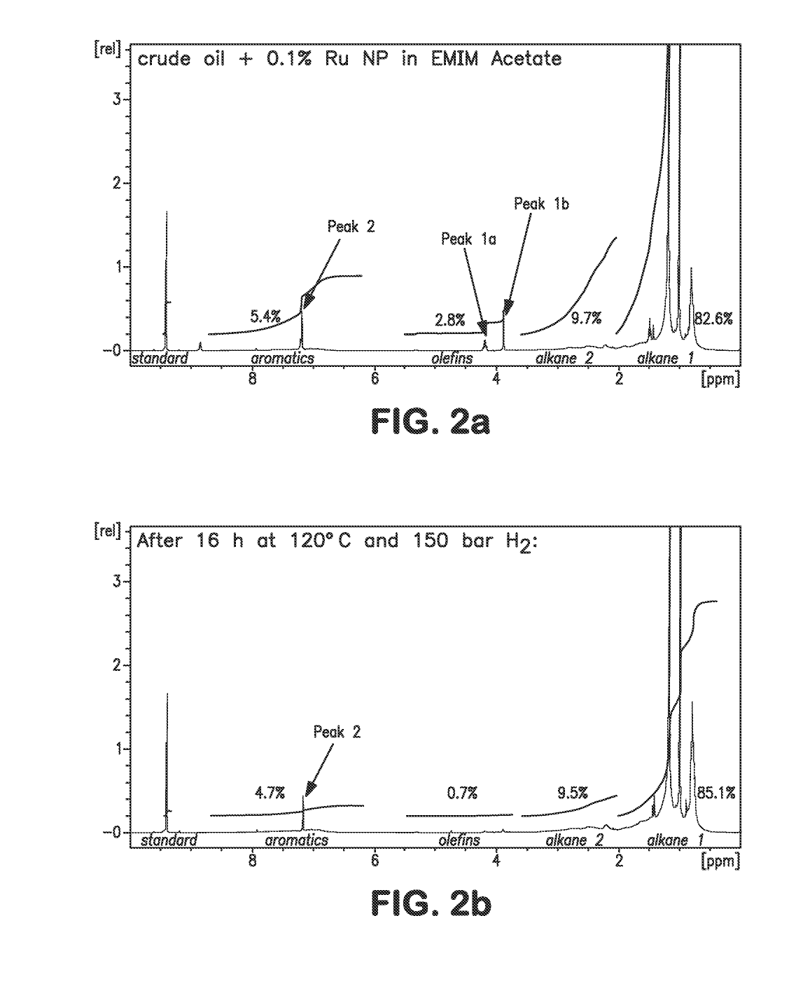

FIG. 1 illustrates an embodiment of the heavy oil recovery method 100. A vertical wellbore 101 comprising an outer sleeve 102 and an inner bore 103 driven into reservoir 105 is connected to a bottom wellbore portion 106. The bottom wellbore portion 106 comprises a perforated liner section 107 and an inner bore 108.

In operation, hydrogen from hydrogen source 109 and the colloid mixture is driven down outer sleeve 102 to perforated liner section 107 where it percolates into reservoir 105 and penetrates reservoir material to yield a reservoir penetration zone. Heavy oil hydrogenated and de-viscosified by the colloidal dispersion flows down and collects at or around the toe 111 and may be pumped by a surface pump through inner bores 108 and 103 through a motor at the wellhead 114 to a production tank 115 where oil and the colloid mixture are separated and the colloid mixture may be recycled as shown. De-viscosified oil may also be producible into the well without operation of a pump, or may alternatively be produced through a second well located some distance from the injection well referred to above. Colloidal material may equally adsorb to the rock downhole and not be produced. In such a scenario, oil flowing through the pores containing the adsorbed colloidal catalyst would be upgraded as it flows through these pores.

The colloid mixture (e.g. colloidal catalyst and liquid dispersant) with hydrogen gas may be injected at high pressure into the reservoir through the vertical well. The reservoir accommodates the injected dispersion by diffusion of pore fluids. The colloidal dispersion mixes with the reservoir heavy oil deposits and the mixture is then produced from the same well, or a second well located some distance from the injection well. Fluids are driven to the production well by formation re-compaction, fluid expansion and gravity.

Without being limited by theory, upon injection of the catalysts within the reservoir, the catalysts may catalyze hydrogenation reactions of the injected hydrogen and the oil deposits within the reservoir. The hydrogenation of the oil may reduce the viscosity to facilitate extraction of the oil from the reservoir. Furthermore, the carrier fluid may additionally reduce the viscosity of the oil. Accordingly, the disclosed method may have the advantage of including two means of reducing the viscosity of oil.

The colloidal catalysts to be used in the disclosed method are particles having an average diameter on the nano or micron scale. More particularly, the colloidal catalysts have an average diameter ranging from about 1 nm to about 100 μm, alternatively ranging from about 10 nm to about 10 μm, alternatively ranging from about 100 nm to about 1 μm. Preferably, the colloidal catalysts are nanoparticles.

The catalysts are preferably capable of catalyzing hydrogenation reactions of certain hydrocarbons at formation temperatures (e.g. the ambient temperature of the reservoir) and also are preferably form colloids in solution. Any suitable catalysts with the desired characteristics (i.e. dispersability in liquids, catalysis of hydrogenation reactions at low temperatures) may be used. Specifically, the catalyst is capable of catalyzing hydrogenation reactions at a temperature ranging from about 10° C. to about 250° C., alternatively from about 25° C. to about 200° C., alternatively from about 50° C. to about 150° C.

In addition, the colloidal catalysts may be made form any suitable catalytic materials while retaining the desired properties. Examples of suitable materials include without limitation, Pd, Au, Ag, Pt, Cu, Ru, Co, Mn, Fe, Ni, Va, Cd, or combinations thereof. In one embodiment, the catalyst may comprise nanoparticles disposed within micelles. The micelles may comprise any suitable materials. In particular, the micelles may comprise polymers, block copolymers, random copolymers, surfactants, anionic surfactants, ionic surfactants, non-ionic surfactants, or combinations thereof. Other possible catalysts are described in Jessop, Journal of Supercritical Fluids, 38 (2006) 211-231, incorporated herein by reference in its entirety for all purposes.

In an exemplary embodiment, the colloidal catalysts are bimetallic Pd/Au nanoparticles disposed within polymeric micelles. The hydrogenation of pentyne to pentane has been demonstrated using these catalysts at temperatures of 50° C. Niessen et al., Journal of Molecular Catalysis, 2002, vol. 182-3, pp. 463-470 incorporated by reference in its entirety for all purposes.

The liquid dispersant may be any suitable liquid which is capable of keeping the colloidal catalyst dispersed in solution. Examples of liquid dispersants include without limitation, ionic liquids, water, organic solvents, and the like. In some embodiments, the liquid dispersant comprises a polar, organic compound. In particular, liquid dispersant is a supercritical carrier fluid such as without limitation, carbon dioxide. There are many advantages to using supercritical fluids. A few of these advantages are true for all supercritical fluids and essentially all reactions: mass transfer is very rapid, the supercritical fluids are completely miscible with gaseous reactants, and are easy to remove from the product. Some advantages are specific to supercritical CO₂; it is nontoxic, nonflammable, nonhalogenated, and nonpolluting. As long as recycled or waste CO₂ is being used, there is also no net contribution to global warming and does not cause cancer or other long-term health problems.

The carbon dioxide can come from any suitable source. Substantially pure carbon dioxide is preferred, but water-saturated carbon dioxide is acceptable since water (or brine) is usually present in the formation. Usually, the carbon dioxide contains at least 95% carbon dioxide and preferably at least 98% carbon dioxide, the remainder being usually light hydrocarbons. The amount of impurities in the carbon dioxide which can be tolerated is a function of the type of oil to be displaced and the type of displacement operation.

It is contemplated that other fluids may be used in conjunction with the disclosed methods. Other examples of carrier fluids or liquid dispersants include without limitation, water or diesel or other petroleum derivatives. Depending on the fluid used the interaction with the oil in the reservoir will change—some fluids may be better than others depending on the application, or any parallel enhanced oil recovery techniques that are being sought (e.g. water flood, CO₂ flood, solvent flood etc.) Additionally, the carrier fluid may include other components to help reduce the viscosity of the heavy oil. Examples of such components include without limitation, an alcohol, water, a surfactant, polymers, hydrocarbons, or combinations thereof.

If using CO₂ as a carrier, the supercritical carbon dioxide is injected so that under the conditions which prevail in the reservoir it is present as a dense phase, that is, it is under supercritical conditions and present neither as a liquid or a dense vapor. Generally, this will be achieved by maintaining pressure in the reservoir sufficiently high to maintain the carbon dioxide in the desired dense-phase state, i.e. at a density greater than approximately 0.4 g/cm³. Methods of injecting supercritical carbon dioxide are known in the art as described in U.S. Pat. Nos. 4,609,043 and 6,305,472, incorporated herein by reference in its entirety for all purposes.

The minimum pressure necessary to maintain the dense-phase state increases with increasing reservoir temperature; the pressure should therefore be chosen in accordance with the reservoir temperature. Typical minimum pressures for maintaining the dense-phase state are about 6200 kPa at 30° C., about 8200 kPa at 38° C., about 12400 kPa at 65° C., about 1720 at 93° C., about 21400 kPa at 120° C.

The colloidal catalyst may be pre-mixed with the liquid dispersant or may be mixed in situ at the reservoir. Furthermore, the colloidal catalyst may be dispersed in the liquid dispersant at any suitable concentration. In particular, the colloidal catalyst may be dispersed at a concentration ranging from about 0.000001 wt % to about 10 wt %, alternatively from about 0.0001 wt % to about 1 wt %, alternatively from about 0.001 wt % to about 0.1 wt %.

The hydrogen used in embodiments of the method may be obtained from a variety of sources. In general, the hydrogen may be prepared by well known methods, such as reforming or noncatalytic partial oxidation. The fuel for manufacture of hydrogen by such methods may be a gas fraction or a liquid fraction from the produced oil, or the gas or coke produced from thermal cracking of the viscous oil or tar. Cracking occurs to some extent in the formation, depending, of course, on the temperature. However, the lighter oil fractions may be separated from the oil produced and used as a reformer fuel in a known manner. An impure hydrogen stream such as that obtained by reforming without carbon dioxide removal may be employed the in situ hydrogenolysis process. In some instances, carbon dioxide removal, or partial removal, by any of the well known methods may be advisable. The reformer product, which contains approximately 35 to 65 percent hydrogen, may be injected directly into the formation since the normal remaining impurities do not interfere to any substantial degree with the desired hydrogenolysis reaction. However, the hydrogen partial pressure in the formation must be high enough to maintain the desired hydrogenation and hydrogenolysis reactions. As an alternative to the reforming methods of hydrogen production, there may be employed partial oxidation of any or all fractions of the produced oil; the hydrogen, CO, CO₂, H₂S mixture may be further processed to produce a stream which is more or less pure hydrogen.

In an embodiment, the hydrogen may be mixed with the liquid dispersant at any suitable concentration and injected together into the reservoir. More particularly, the hydrogen may be injected at a concentration ranging from about 0.05% to about 50%, alternatively from about 0.5% to about 5%, alternatively from about 0.1% to about 1% depending on the degree of hydrogenation sought, the pressure of the reservoir, and other factors.

Alternatively the hydrogen could be injected through a different well than is used for injection of the catalyst. Because injected hydrogen dissolves in reservoir oil and diffuses readily throughout the reservoir, alternative injection points may be used to those used for catalyst injection. In such embodiments, the hydrogen may be injected before catalyst injection and allowed to permeate the reservoir for certain amount of time before injection of the colloidal catalyst. The catalyst would then be injected afterwards and allowed to react with the oil and the permeated hydrogen. In some embodiments, hydrogen and catalyst may be injected simultaneously, but each at different locations in the formation.

After the colloid mixture and dissolved hydrogen gas is injected, it may be allowed to remain in contact with the heavy oil at reservoir conditions until samples taken periodically from the producing wells show that the produced oil viscosity is low enough considering the temperature, porosity, and pressure of the formation to obtain economical oil production. Depending on the conditions of the reservoir and the characteristics of the heavy oil, the time of contact of mixture with the oil may vary widely. This period may be known as a “catalytic soak” period. This time period may range from about 0.1 days to about 1000 days, alternatively from about 1 days to about 100 days, alternatively from about 1 day to about 10 days. The viscosity of the oil may be reduced by an amount ranging from about 10% to about 80%, alternatively by an amount ranging from about 25% to about 75%, alternatively by an amount ranging from about 30% to about 50%.

Embodiments of the above disclosed method may be used in conjunction with other heavy oil recovery methods including without limitation, steam flood, water flood, solvent flood, steam stimulation, or combinations thereof.

### Example

Heavy oil was reacted with ruthenium colloidal dispersion in the presence of hydrogen. To make the colloidal dispersion, the ruthenium nanoparticles were dispersed in an ionic liquid. After pressurizing to 60 bar with hydrogen, the solution of ruthenium and ionic liquid was stirred for 2 hours at 60° C. The different ionic liquids (1-butyl-3-methylimidazolium (BMIM) acetate and 1-ethyl-3-methylimidazolium (EMIM) acetate) tested are shown along with their viscosities before and after reaction in Table 1 below.

The ruthenium nanoparticles were reacted with heavy oil samples at 120° C., 150 bar H₂, and 16 h. The heavy oil samples were actual samples taken from a test well. Results of the viscosity of heavy oil after reaction with ruthenium stabilized with two different ionic liquids at 120° C. are shown in Table 1.

TABLE 1

| | Ionic Liquid | Viscosity [mPa · s] |
|---|---|---|
| Crude oil | — | 280.9 |
| a | BMIM Acetate | 517.0 |
| b | BMIM Acetate | 331.0 |
| a | EMIM Acetate | 408.6 |
| b | EMIM Acetate | 160.64 |

crude oil, 0.1 wt-% Ru, 3.9 wt-% IL a: before reaction, b: 150 bar H₂, 120° C., 16 h

According to the results in Table 1, the viscosity of the oil was reduced by about 43% by the ruthenium nanoparticles stabilized in EMIM acetate. Although not shown in the data above, the EMIM acetate actually increases the viscosity of the heavy oil before reaction. Thus, dispersing the ruthenium nanoparticles in a lower viscosity liquid dispersant may actually enhance the reduction in viscosity even more so than shown in the test results.

As further evidence that the ruthenium nanoparticles catalyzed reactions of the heavy oil, the H¹ NMR spectrum before after 16 hours of reaction are shown in FIGS. 2a and 2b. Peaks 1a and 1b in FIG. 2a shows the presence of olefins in the heavy oil. However, after 16 hours reaction, peaks 1a and 1b have virtually disappeared, which indicates hydrogenation reactions of alkenes and aromatics have taken place as catalyzed by the ruthenium colloidal catalyst. Furthermore, peak 2 in FIG. 2a which indicates the presence of aromatics has decreased in FIG. 2b, again revealing hydrogenation reactions with the aromatics in the heavy oil. The decreased presence of olefins along with lower concentration of aromatics likely significantly contributed to the decreased viscosity of the heavy oil sample.

While the embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

The discussion of a reference is not an admission that it is prior art to the present invention, especially any reference that may have a publication date after the priority date of this application. The disclosures of all patents, patent applications, and publications cited herein are hereby incorporated herein by reference in their entirety, to the extent that they provide exemplary, procedural, or other details supplementary to those set forth herein.

What is claimed is:

1. A method of oil recovery comprising:
a) mixing a colloidal catalyst with a liquid dispersant to form a colloidal dispersion, wherein the colloidal catalyst comprise nanoparticles;
b) injecting hydrogen and the colloidal dispersion into a subterranean formation containing oil, the subterranean formation having a formation temperature; and
c) allowing the hydrogen and the colloidal dispersion to diffuse into the subterranean formation and react with the oil, wherein the colloidal dispersion catalyzes hydrogenation of the oil at a temperature no greater than the formation temperature to reduce the viscosity of the oil.

2. The method of claim 1 wherein (b) comprises injecting the hydrogen before the colloidal dispersion.

3. The method of claim 1 wherein (b) comprises injecting the hydrogen at a different location than the colloidal dispersion.

4. The method of claim 1 wherein the hydrogen is mixed with other gases.

5. The method of claim 1 wherein the colloidal catalyst comprises a polymeric micelle.

6. The method of claim 5 wherein the polymeric micelle comprises polystyrene-block-polyvinylpyridine.

7. The method of claim 1 wherein the colloidal catalyst comprises Pd, Au, Ag, Pt, Cu, Ru, Co, Mn, Fe, Ni, Va, Cd, or combinations thereof.

8. The method of claim 1 wherein the oil comprises heavy oil, bitumen, light oil, or combinations thereof.

9. The method of claim 1 wherein the liquid dispersant is a supercritical fluid.

10. The method of claim 1 wherein the supercritical fluid comprises supercritical CO₂.

11. The method of claim 1 wherein the colloidal catalyst catalyzes hydrogenation at a temperature no more than about 120° C.

12. The method of claim 1 wherein the liquid dispersant further comprises alcohols, solvents, water, surfactants, polymers, hydrocarbons, or combinations thereof.

13. The method of claim 1 wherein (a) comprises mixing the colloidal catalyst with the liquid dispersant at a concentration ranging from about 0.000001 wt % to about 10 wt %.

14. The method of claim 1 wherein the hydrogen and the colloidal dispersion are mixed before (b).

15. The method of claim 1 wherein (c) comprises allowing the hydrogen and the colloidal dispersion to diffuse into the subterranean formation and react with the heavy oil for a period ranging from about 0.1 days to about 1000 days.

16. The method of claim 1 wherein the concentration of hydrogen with respect to the colloidal dispersion ranges from about 0.05 wt % to about 50 wt %.

17. The method of claim 1 wherein the colloidal catalyst causes hydrogenation of the oil so as to reduce the viscosity of the oil by at least about 40%.

18. A method of reducing heavy oil viscosity to enhance heavy oil recovery comprising injecting catalytic nanoparticles dispersed in a liquid dispersant into a subterranean formation containing heavy oil.
